(19) United States
(12) Patent Application Publication
(10) Pub. No.: US 2007/0251044 A1
(43) Pub. Date: Nov. 1, 2007

(54) Profile Rail for Vertebra of Blade Rubber of Window Screen Wiper

(75) Inventors: Ludo Adriaensen, Deerlijk (BE); Ali Sarban, Avelgem (BE)

Correspondence Address: FOLEY AND LARDNER LLP;SUITE 500, 3000 K STREET NW, WASHINGTON, DC, 20007, US

(73) Assignee: NV BEKAERT SA

(21) Appl. No.: 11/661,602

(22) PCT Filed: Jun. 1, 2005
(86) PCT No.: PCT/EP05/53132

§ 371 Date: Mar. 29, 2007

(30) Foreign Application Priority Data
Sep. 2, 2004 (EP) 04104213.6

(51) Int. Cl. B60S 1/34

(52) U.S. Cl. 15/250.351

(57) ABSTRACT

A rail (22′, 22″) for the vertebra of the blade rubber (10) of a windscreen wiper has over its entire length a substantially constant cross-section deviating from a rectangular cross-section. The rail (22′, 22″) has a moment of inertia I, has a particular width and has a particular surface area. The moment of inertia I is larger than the moment of inertia of a rectangular wire with a same width and a same surface area. The cross-section has a circumference exhibiting both convex and concave portions. The rail is made of a drawn or rolled steel wire. The typical cross-section of the rail allows to have a stiffer structure without increasing the weight.

### FIELD OF THE INVENTION

The present invention relates to a rail or rails forming the vertebra of the blade rubber of a windscreen wiper.

The present invention also relates to a windscreen wiper comprising one or more such rails.

### BACKGROUND OF THE INVENTION

Prior art windscreen wipers are provided with a vertebra having a blade rubber. The blade rubber has one or more slots or recesses where one or more rails may fit. The rails function as a spring, which transmits forces to the blade rubber to hold the blade rubber in contact with the surface of the windscreen. The rails may be in the form of a flattened wire or a wire with a rectangular cross-section.

Commonly the vertebra has a length varying from 450 to 550 mm for windscreens of passenger cars and going up to 850 mm for windscreens of trucks. The latter case means that a lever of more than 400 mm is created. In order to hold the blade rubber in close contact with the surface of the windscreen during its working, a smaller deflection is desired for the spring functioning of the rail. This smaller deflection can be realized by increasing the thickness of the rail. This increase in thickness, however, also increases the weight, which is unacceptable in a number of cases having regard to the above-mentioned dimensions.

### SUMMARY OF THE INVENTION

It is a first object of the present invention to avoid the drawbacks of the prior art.

It is a second object of the present invention to decrease the deflection of the spring rail without increasing its weight or volume.

It is a third object of the present invention to provide alternative rails for the vertebra of the blade rubber of a windscreen wiper.

According to a first aspect of the present invention, there is provided a rail for the vertebra of the blade rubber of a windscreen wiper. The rail has over its entire length a substantially constant cross-section deviating from a rectangular cross-section. The rail has a moment of inertia I, has a particular width and has a particular surface area. The moment of inertia I of the invention rail is larger than the moment of inertia of a rectangular wire with a same width and a same surface area. The cross-section of the invention rail has a circumference exhibiting both convex and concave portions. As a particular embodiment, the rail has a cross-section selected from a group consisting of an I-form, a U-form, and an L-form. Preferably the rail has a said cross-section with rounded edges. The rail is preferably made of steel, most preferably out of a plain carbon steel. The rail is made of a drawn and/or rolled steel wire. The advantages of rolling or drawing are as follows.

Rolling and drawing are a continuous way of manufacturing and, hence, very economical. In addition, the rolling and drawing step increase the strength of the steel wire so that the steel wire gets more adapted to properly function as a spring.

The typical cross-section of the rail allows to have a stiffer structure without increasing the weight.

An explanation for the working of the invention can be given with the help of following formula, which relates to the working of a cantilever spring or of a simple beam spring.
F=P×L³/[48×E×I]
where

F is the deflection;

P is the exercising force;

L is the length of the spring;

E is the E-modulus of elasticity or Young's modulus;

I is the moment of inertia.

When it comes to the choice of the type of rail, E and I are the only parameters that can be changed.

The E-modulus can be maximized, and thus the deflection minimized, by selecting stainless steel as material for the rail, or even better, by selecting plain carbon steel. The E-modulus for stainless steel varies between about 185000 MPa and 190000 MPa. The E-modulus for plain carbon steel varies between 205000 MPa and 210000 MPa.

The formula for the moment of inertia I for a rectangular wire is
I=w×t³/12
where

w is the width of the rail

t is the thickness of the rail.

Increasing the thickness of the wire is very effective since the moment of inertia I is directly proportional to the third power of the thickness t. However, increasing the thickness is often unacceptable since it increases the surface area of the rail and consequently the weight of the rail.

As will be explained hereinafter, the invention aims at providing a rail with a profile cross-section deviating from a rectangular cross-section and having a moment of inertia I that is greater than the moment of inertia of a comparable “reference” rectangular cross-section.

EP-A1-0 463 865 discloses a vertebra for the blade rubber of a windscreen wiper where the cross-section of the rails varies along the length of the rail in order to obtain a varying degree of flexibility of the rail along its length. In contrast herewith, the rail according to the invention has a substantially constant cross-section over its entire length.

FR-A1-2 753 945 discloses a vertebra for the blade rubber of windscreen wiper where the cross-section of the rail has a convex profile and may be, e.g., circular or elliptical. The reason for this convex profile is to facilitate the fixing of the rail in the blade rubber. As explained in FR-A1-2 753 945, the convex profile allows an elastic housing of the rail in the blade rubber and simplifies the construction. The profiles disclosed in FR-A1-2 753 945 do not have a cross-section with concave parts in the circumference.

US-A1-2003/0138655 discloses a wiper blade and a reinforcement for the wiper blade. The cross-section of this reinforcement may take various forms such as forms the circumference of which has both convex and concave portions.

Similarly, GB-A-2 005 532 discloses a windscreen wiper with a stabilizing bar. The cross-section of this bar may take the form of a V-sectioned stiffening rib or web, and hence, has a circumference with both convex and concave portions.

In contrast with the present invention, however, both US-A1-2003/0138655 and GB-A-2 005 532 do not disclose reinforcements or bars of drawn or rolled steel. The reinforcements or bars disclosed in both US-A1-2003/0138655 and GB-A-2 005 532 are made of strip which is deep drawn in a direction vertical to the longitudinal direction of the reinforcement or bar, in order to give the reinforcement or bar its particular shape. This deep drawing is not to be confused with the wire drawing step which is a process of drawing the wire through a die in its longitudinal direction in order to realize a reduction in cross-section. Deep drawing does not increase the strength of the strip.

According to a second aspect of the present invention, there is provided a windscreen wiper comprising one, two or more rails according to the first aspect of the present invention.

### BRIEF DESCRIPTION OF THE DRAWINGS

The invention will now be described into more detail with reference to the accompanying drawings wherein

FIGS. 1a, 1b, 1c, 1d, 1e and 1f all illustrate various positions of a preferable embodiment of a rail according to the invention in a blade rubber of a windscreen wiper;

FIGS. 2a, 2b, 2c and 2d illustrate various positions of another embodiment of a rail according to the invention in a blade rubber of a windscreen wiper;

FIG. 3 illustrates a preferable embodiment of a rail according to the invention in another type of blade rubber;

FIG. 4 illustrates a preferable embodiment of rails according to the invention in yet another type of blade rubber;

FIG. 5a illustrates in general the positioning of a reference rail in a blade rubber and FIGS. 5b, 5c, 5d, 5e, 5f, 5g, 5g and 5h show various profiles for rails according to the invention;

FIG. 6a shows a cross-section of a reference rail and

FIGS. 6b, 6c, 6d, 6e and 6f show cross-sections of rails according to the invention.

### DESCRIPTION OF THE PREFERRED EMBODIMENTS OF THE INVENTION

A rail according to the invention can be made starting from a wire steel rod with a carbon content varying between 0.60 and 0.90 weight percent. The wire rod is hard drawn until an intermediate diameter. The hard drawn wire is thereafter rolled until the desired final profile is obtained. This rolling can be done by means of rolls or by means of Turk's heads. Alternatively the wire can be drawn through a series of profile dies until the final profile is obtained.

In a preferable embodiment of the invention, the wire is hardened and tempered so that a martensitic structure is obtained. The steel for such a wire comprises small amounts of chromium, silicon and vanadium. The rail made of such a wire has the advantage of having a high degree of hardness and a high degree of fatigue resistance.

A corrosion protection can be provided by galvanizing the steel wire in a bath of zinc or of a zinc alloy, such as zinc aluminum. The amount of aluminum in the zinc aluminum alloy may vary between 1% and 10%, e.g. between 2% and 8%. For example, a zinc aluminum coating with a thickness varying between 50 μm and 80 μm (25 g/m² to 60 g/m²) can be given to the steel wire. Alternatively, or in combination with the zinc alloy coating, a polymer coating can be given to the steel wire, e.g. by means of an extrusion process.

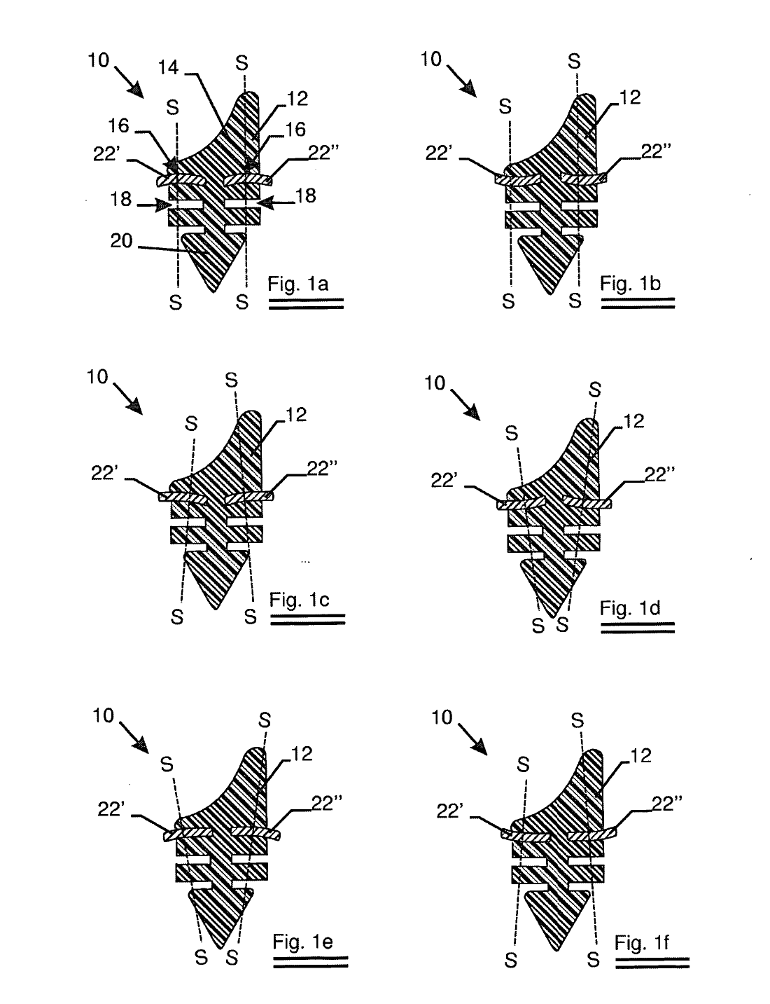

FIG. 1a shows the cross-section of a blade rubber 10 reinforced by means of a preferable embodiment of a vertebra. Blade rubber 10 comprises a matrix of rubber 12. The upper part of rubber 12 forms a type of spoiler 14. In the body of the blade rubber upper grooves or recesses 16 and lower grooves or recesses 18 are made. The lower part of rubber 12 is a head 20, which is to come into contact with the windscreen. A left rail 22′ and a right rail 22″ in the form of a bean occupy the upper grooves 16 and form the vertebra. The rails 22′ and 22″ have a cross-section in the form of a bean. The cross-section has a convex part and a concave part. As has been tested and as will be described hereafter, this type of rail has a moment of inertia I_{ref}, which is greater than the moment of inertia I_{ref} of a reference rectangular wire with the same width w and the same surface area A. This type of rails form a preferable embodiment of the invention, since they can be easily manufactured starting from a rectangular or flattened steel wire and giving to the rectangular or flattened steel wire an additional and final rolling treatment.

FIG. 1a illustrates one particular example of the positioning of bean-like rails 22′, 22″ in the rubber 12: with vertical axes of symmetry SS and with the concave part pointing downwards and the convex part pointing upwards.

FIGS. 1b through 1f all illustrate other positions of bean like rails 22′ and 22″ in the rubber 12.

FIG. 1b: vertical axes, concave part pointing upwards and convex part pointing upwards.

FIG. 1c: axes running obliquely towards each other upwards, and with the concave part pointing downwards and the convex part pointing upwards.

FIG. 1d: axes running obliquely towards each other downwards, and with the concave part pointing upwards and the convex part pointing downwards.

FIG. 1e: axes running obliquely towards each other downwards, and with the concave part pointing downwards and the convex part pointing upwards.

FIG. 1f: axes running obliquely towards each other upwards, and with the concave part pointing upwards and the convex part pointing downwards.

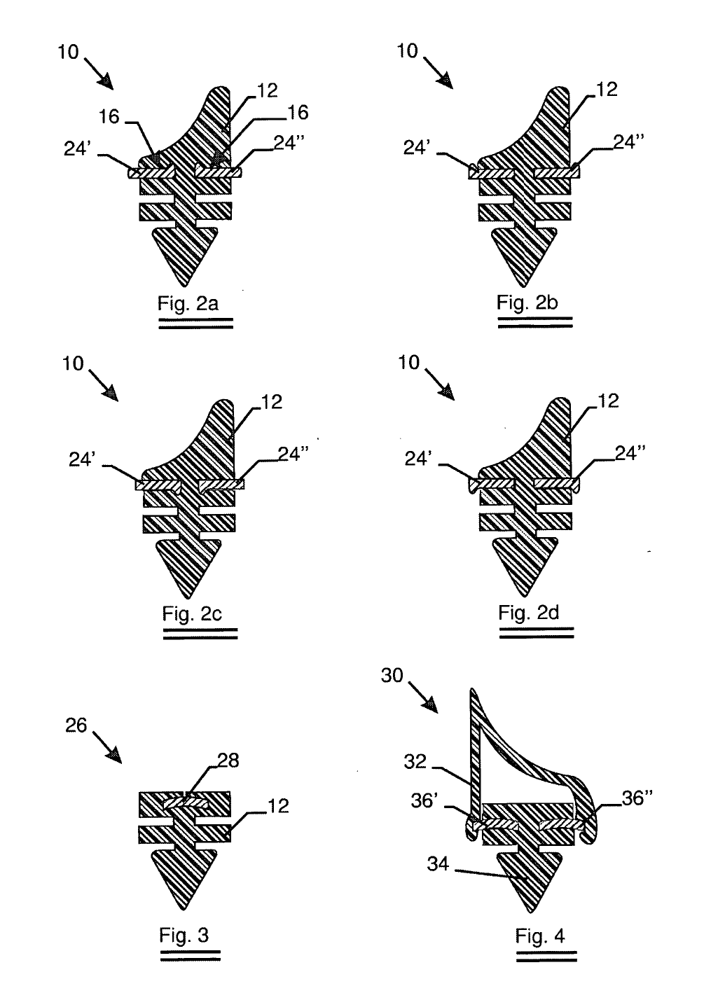

FIG. 2a shows the cross-section of a blade rubber 10 reinforced by means of an alternative embodiment of a vertebra. The vertebra is now formed by two rails 24′, 24″, which have a thickened part at one side. Here again, this type of rail has a moment of inertia I_{ref}, which is greater than the moment of inertia I_{ref} of a reference rectangular wire with the same width w and the same surface area A.

In FIG. 2a the positioning of rails 24′ and 24″ is such that the thickened parts are close to each other and point upwards.

FIGS. 2b, 2c and 2d all illustrate other positions of rails 24′ and 24″.

FIG. 2b: the thickened parts are remote from each other and point upwards.

FIG. 2c: the thickened parts are close to each other and point downwards.

FIG. 2d: the thickened parts are remote from each other and point downwards.

FIG. 3 shows the cross-section of another type of blade rubber 26 where the vertebra is formed by a single steel rail 28 in the form of a bean with the convex part pointing downwards.

FIG. 4 shows the cross-section of yet another type of blade rubber 30. The vertebra is here formed by two steel rails 36′ and 36″ which have the form of a bean with the convex part pointing downwards. The difference between this type of blade rubber 30 and the types illustrated in FIGS. 1 and 2, is that blade rubber 30 has a hollow spoiler part 32 which covers completely the rails 36′ and 36″. Such an embodiment adds additional corrosion protection to the rails 36′ and 36″.

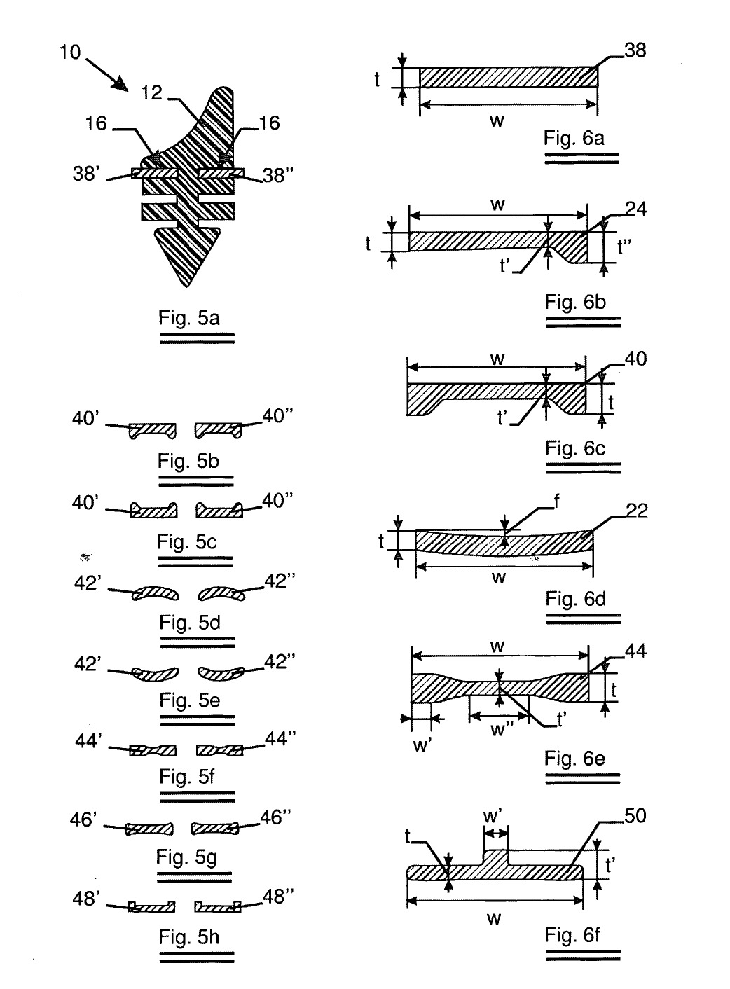

FIG. 5a illustrates a cross-section of a prior art blade rubber 10 where prior art rectangular steel rails 38′ and 38″ are embedded in the upper grooves 16.

FIGS. 5b through 5h all show rails according to the invention with a profile deviating from a rectangular profile.

FIG. 5b shows cross-sections of rails 40′, 40″ each having a cross-section a thickened parts at both ends. The thickened parts point downwards.

FIG. 5c shows cross-sections of rails 40′, 40″ each having a cross-section a thickened parts at both ends. The thickened parts now point upwards.

FIG. 5d shows cross-sections of rails 42′, 42″ each having the cross-section of bean-like elements with rounded edges. The concave parts are pointed downwards.

FIG. 5e shows cross-sections of rails 42′, 42″ each having the cross-section of bean-like elements with rounded edges. The concave parts are pointed upwards.

FIG. 5f shows cross-sections of rails 44′, 44″ each having a cross-section with thickened parts at both ends and a smaller part in the middle.

FIG. 5g shows cross-sections of rails 46′, 46″, which are somewhat similar to the ones of FIG. 5f. The thickened parts in the rails 46′, 46″ are, however, limited in width.

FIG. 5h shows cross-sections of rails 48′, 48″, each having a U-profile.

The surface area A and moment of inertia I have been determined for a number of profile rails according to the invention.

These values have been compared with a “reference” rail with a rectangular section and with the same width w and surface area A as the profile rail.

The values of the moment of inertia I have also been divided by the values of the surface area A in order to obtain specific moment of inertia.

FIG. 6a shows the cross-section of the reference rail 38 and FIGS. 6b, 6c, 6d, 6e and 6f show cross-sections of profile rails according to the invention.

The geometry of the various cross-sections is as follows.

FIG. 6a: Reference rail 38 has a cross-section with a width w equal to 9.0 mm and a thickness t equal to 1.0 mm.

FIG. 6b: Invention rail 24 has a cross-section with a width w equal to 9.0 mm, a thickness t equal to 1.0 mm, a smallest thickness t′ equal to 0.8 mm, and a thickness t″ equal to 1.5 mm. The smallest thickness t′ is situated at 2 mm from the thickest edge.

FIG. 6c: Invention rail 40 has a width w equal to 9.0 mm, a thickness t equal to 1.5 mm and a smallest thickness t′ equal to 0.8 mm. The width of the part with the smallest thickness t′ is equal to 5.0 mm.

FIG. 6d: Invention rail 22 has a width w equal to 9.0 mm, a thickness t equal to 1.0 mm and a deflection f equal to 0.3 mm.

FIG. 6e: Invention rail 44 has a width w equal to 9.0 mm, a thickness t equal to 1.5 mm, a smallest thickness t′ equal to 0.7 mm. The width w″ of the part with the smallest thickness t′ is 3.0 mm, and the widths w′ of the parts with the greatest thicknesses t are 1.0 mm.

FIG. 6f: Invention rail 50 has a width w equal to 9.0 mm, a thickness equal to 0.7 mm, a greatest thickness t′ equal to 1.5 mm. The width w′ of the thickest part is equal to 1.2 mm.

The table hereunder summarizes the results.

TABLE

| | | | Thickness | Moment | | |
|---|---|---|---|---|---|---|
| | | Moment | h of | of | | |
| | | of | reference | inertia | | |
| Number | Surface A | inertia I | wire | I_{ref} | | |
| rail | (mm²) | (mm⁴) | (mm) | (mm⁴) | I/I_{ref} | I/A |
| FIG. 6a:38 | 9.000 | 0.750 | 1.000 | 0.750 | 1.000 | 0.083 |
| FIG. 6b:24 | 8.787 | 0.846 | 0.976 | 0.697 | 1.215 | 0.096 |
| FIG. 6c:40 | 9.009 | 1.097 | 1.001 | 0.752 | 1.458 | 0.122 |
| FIG. 6d:22 | 9.000 | 0.8222 | 1.000 | 0.750 | 1.096 | 0.091 |
| FIG. 6e:44 | 9.511 | 1.150 | 1.057 | 0.885 | 1.299 | 0.121 |
| FIG. 6f:50 | 7.466 | 0.869 | 0.830 | 0.428 | 2.030 | 0.116 |

The last but one column with the values of I/I_{ref} gives relevant information in that it indicates the degree with which a profile rail has a moment of inertia deviating from a moment of inertia of a rectangular wire. As the values of I/I_{ref} are all more than 1.0, this means that all profile rails have a moment of inertia that is greater than the moment of inertia I_{ref} of a rectangular wire with the same width and with the same surface area A.

Invention rail 50 of FIG. 6f has the highest value of I/I_{ref} and represents another preferable embodiment of the invention.

The last column with the values I/A gives the specific values of the moment of intertia. For a given material, e.g. plain carbon steel, it gives the moment of inertia per unit weight.

Invention rail 40 of FIG. 6c has the highest value of I/A.

1. A rail for the vertebra of the blade rubber of a windscreen wiper, said rail having over its entire length a substantially constant cross-section deviating from a rectangular cross-section, said rail having a moment of inertia I, having a particular width and having a particular weight,
said moment of inertia I is larger than the moment of inertia of a rectangular wire with a same width and a same weight,
said cross-section having a circumference exhibiting both convex and concave portions, said rail being made of a drawn or rolled steel wire.

2. A rail according to claim 1, wherein said rail has a cross-section selected from a group consisting of an I-form, a U-form, and an L-form.

3. A rail according to claim 1, wherein said cross-section has rounded edges.

4. A rail according to claim 1, wherein said rail is made of a plain carbon steel.

5. A rail according to claim 4, wherein said rail is made of hardened and tempered steel.

6. A rail according to claim 1, wherein said rail is made of stainless steel.

7. A windscreen wiper comprising one rail according to claim 1.

8. A windscreen wiper comprising two rails according to claim 1.
